(19) United States
(12) Patent Application Publication
(10) Pub. No.: US 2021/0062491 A1
(43) Pub. Date: Mar. 4, 2021

(54) TOILET APPARATUS AND METHOD FOR FLUSHING HUMAN BODY USING SAME

(71) Applicant: Kehan CAO, Beijing (CN)

(72) Inventors: Kehan CAO, Beijing (CN); Naicheng CAO, Beijing (CN)

(21) Appl. No.: 17/031,500

(22) Filed: Sep. 24, 2020

Related U.S. Application Data
(63) Continuation of application No. PCT/CN2019/078406, filed on Mar. 16, 2019.

(30) Foreign Application Priority Data
Mar. 26, 2018 (CN) 201810254269.0

(51) Int. Cl. E03D 9/08; G05D 3/20; G06T 7/73; G06K 9/00; G06T 7/00

(52) U.S. Cl. CPC E03D 9/08; G05D 3/20; G06T 7/75; G06K 9/00362; G06T 2207/30088; G06T 7/0012; G06T 2207/10028; G06T 2207/30196; G06K 9/00201

(57) ABSTRACT

An intelligent toilet apparatus and a method for cleaning human body using the same. The toilet apparatus includes a measurement module configured to perform a three-dimensional measurement of the human body within the toilet seat to obtain a three-dimensional point cloud and establish a three-dimensional model of the human body based on the three-dimensional point cloud; a recognition module configured to recognize certain parts of the human body according to the three-dimensional point cloud and/or the three-dimensional model; and a flushing control module configured to control a flushing execution module to move towards the part that needs to be cleaned according to its spatial position and flush it with water flow.

### CROSS-REFERENCE TO RELATED APPLICATIONS

This application is a continuation of International Patent Application No. PCT/CN2019/078406, filed on Mar. 16, 2019, which claims the benefit of priority from Chinese Patent Application No. 201810254269.0, filed on Mar. 26, 2018. The content of the aforementioned applications, including any intervening amendments thereto, is incorporated herein by reference.

### TECHNICAL FIELD

This application relates to a sanitary ware, and more particularly to a toilet apparatus and a method of flushing human body using the same.

### BACKGROUND

A toilet apparatus, also called closestool, is a common sanitary ware in our daily life. At present, some intelligent closestools have been designed to flush user's anus and other parts after excretion. However, in the existing intelligent closestools, the nozzle is usually fixed, and cannot be automatically adjusted according to the height and sitting position of the users. Some intelligent closestools are equipped with horizontally-adjustable nozzles, but its still requires manual operation, which is not very convenient.

### SUMMARY

The present disclosure aims to provide a toilet apparatus that can automatically determine the position of various parts of the human body and then automatically adjust the position of the flushing nozzle to accurately flush the corresponding part of the human body.

Technical solutions of the disclosure are specifically described as follows.

In a first aspect, the disclosure provides a toilet apparatus, comprising:

a toilet seat;

a water supply system;

at least one flushing module;

at least one measurement module; and

at least one recognition module;

wherein the flushing module comprises at least one flushing execution module and at least one flushing control module;

wherein the measurement module is configured to perform a three-dimensional (3D) measurement of a human body within the toilet seat to obtain a 3D point cloud of a surface of the human body within the toilet seat, and

the measurement module is configured to establish a 3D model of the human body according to the 3D point cloud;

the recognition module is configured to identify certain parts of the human body within the toilet seat according to the 3D point cloud and/or the 3D model of the human body, and calculate a 3D position of each of the certain parts; and

the flushing control module is configured to control the flushing execution module to move towards a part that needs to be cleaned according to its 3D position and flush the part with a flushing water flow.

In an embodiment, the measurement module comprises a measurement control module and a measurement execution module; the measurement control module is configured to control the measurement execution module to perform 3D measurement of the human body within the toilet seat to obtain the 3D point cloud; and the measurement control module is operable to establish the 3D model according to the 3D point cloud.

In an embodiment, the toilet apparatus further comprises:

at least one terminal comprising at least one of the recognition module, the flushing control module and the measurement control module.

In an embodiment, the flushing execution module comprises a water pump, a flushing nozzle and a first servo-mechanism; and the first servo-mechanism is configured to drive the flushing nozzle to move towards and flush the part that need to be cleaned.

In an embodiment, the measurement execution module comprises at least one camera, at least one line laser and a second servo-mechanism;

the camera and the line laser are arranged below the toilet seat; the line laser is configured to emit linear laser beams to irradiate the human body within the toilet seat; and the camera is configured to capture images of the surface of the human body within the toilet seat.

In an embodiment, the camera is provided with a filter to allow light having the same wavelength as the linear laser beams to pass through.

In an embodiment, the toilet apparatus further comprises:

at least one collection module;

wherein the collection module comprises a collection execution module and a collection control module;

the collection control module is configured to control the collection execution module to move to a position corresponding to the part that needs to be cleaned according to at least one of the 3D model of the human body, the 3D point cloud and the 3D position of each of the certain parts; and

the collection execution module is configured to collect excrement and/or urine, and water generated after flushing the human body.

In an embodiment, the recognition module is configured to determine gender and/or age of a user according to identified parts of the human body within the toilet seat, and determine the age of the user according to the 3D point cloud and/or the 3D model of the human body.

In an embodiment, the flushing control module is configured to select a flushing option according to the determined gender and/or age of the user.

In an embodiment, the measurement module is configured to monitor defecation and/or urination of the human body in real time; and

the flushing control module is configured to select a flushing option according to the defecation and/or urination information provided by the measurement module.

In an embodiment, the measurement module is configured to detect a 3D shape of each of the certain parts of the human body within the toilet seat and/or a smoothness of a skin of the human body within the toilet seat to determine whether each of the certain parts and/or the skin surface of the human body within the toilet seat is/are in a normal state.

In an embodiment, the measurement module is operable to record and compare results of multiple measurements to determine whether there are progressive changes in the certain parts and/or the skin surface of the human body within the toilet seat.

In an embodiment, the flushing control module is operable to establish a mathematical model and/or a 3D model of the flushing water flow, and establish a corresponding relationship between a position of the flushing nozzle and a part of the human body contacting the flushing water flow and/or a position where the surface of the human body contacts the flushing water flow according to the 3D point cloud and/or the 3D model of the human body and the mathematical model and/or the 3D model of the flushing water flow.

In a second aspect, this application provides a method for flushing a human body by using the toilet apparatus, comprising:

(a) performing 3D measurement on the human body within the toilet seat to obtain the 3D point cloud of the human body;

(b) identifying each of the certain parts of the human body within the toilet seat according to the 3D point cloud; and calculating the 3D position of each of the certain parts; and

(c) moving the flushing execution module to flush a part that needs to be cleaned according to its 3D position.

In an embodiment, the method further comprises:

after step (a), establishing the 3D model of the human body according to the 3D point cloud such that when step (b) is performed, each of the certain parts of the human body within the toilet seat is identified according to the 3D point cloud and/or the 3D model of the human body, and the 3D position of each of the certain parts is calculated.

In an embodiment, the method further comprises:

after step (c), establishing a correspondence relationship between a position of the flushing execution module and a position of the surface of the human body contacting the flushing water flow.

In an embodiment, the method further comprises:

after step (c),

establishing, by the flushing control module, a mathematical model and/or a 3D model of the flushing water flow; and establishing a corresponding relationship between a position of the flushing control module and a position where the flushing water flow contacts the human body and/or the surface of the human body according to the 3D point cloud and/or the 3D model of the human body and the mathematical model and/or the 3D model of the flushing water flow; and

controlling, by the flushing control module, the flushing execution module to move to a position corresponding to a part of the human body that needs to be cleaned according to the corresponding relationship.

In a third aspect, this application also provides a method for detecting skin conditions of a human body by using the toilet apparatus, comprising:

(a) detecting, by the measurement module, a shape of each of the certain parts and/or smoothness of the skin of the human body within the toilet seat; and

(b) determining whether each of the certain parts and/or the skin of the human body within the toilet seat is in a normal state.

In an embodiment, the method further comprises:

after step b, recording and comparing multiple detection results to determine whether there is a progressive change in the certain parts and/or the skin of the human body within the toilet seat.

The toilet apparatus of the disclosure includes a toilet bowl, a toilet seat, a supply water pipe, a discharge module and a flushing execution module.

The flushing execution module comprises a flushing nozzle, a servo-mechanism and a driver circuit. The flushing execution module is configured to move back and forth to accordingly change the position of the flushing nozzle and the flushing water flow. The toilet seat is configured for user to sit on during use.

The toilet apparatus further comprises at least one measurement module, which can is configured to perform a three-dimensional (3D) measurement of the body parts within the toilet seat to obtain a 3D point cloud of surface of the human body within the toilet seat; and establish a 3D model of the human body within the toilet seat.

The toilet apparatus comprises at least one recognition module, which is configured to identify each part of the human body within the toilet seat according to the 3D point cloud and/or the 3D model.

The toilet apparatus comprises at least one flushing control module, which is configured to control the flushing execution module to move according to the spatial position of each part of the human body within the toilet seat, and change the position of the nozzle so that the flushing water flow can accurately flush the parts of the human body that needs to be cleaned.

The flushing control module is operable to establish a mathematical model and/or a 3D model of the flushing water flow, and establish a corresponding relationship between a position of the flushing nozzle and a part of the human body contacting the flushing water flow and/or a position where the body surface contacts the flushing water flow according to the 3D point cloud and/or the 3D model of the human body and the mathematical model and/or the 3D model of the flushing water flow.

After the body parts to be flushed are determined, the flushing control module controls the flushing execution module/the flushing nozzle to move to the corresponding position where the flushing nozzle is corresponding to the body part that needs to be cleaned according to the corresponding relationship. Namely, the flushing control module can determine the position of the flushing nozzle corresponding to any body part that needs to be cleaned according to the corresponding relationship. When a certain part needs to be cleaned, the flushing control module controls the flushing nozzle to move to the position of the flushing nozzle corresponding to the part.

The measurement module is configured to measure the surface morphology of the human body by 3D laser scanning, a time-of-flight (TOF) method, double-sided stereo vision, structured light, ultrasonic measurement, other known manner or a combination thereof to obtain 3d data of the human body and build a 3D human body model.

The measurement module can detect the morphology of various parts of the human body, the smoothness of the skin surface, the skin color, etc., to determine whether each part is in a normal state. The detection items include a 3D morphological detection and visible light/infrared light image detection. Preferably, the measurement module is used to detect whether there are hemorrhoids in the anal area, and whether there are abnormal moles and pigmented areas on the lower skin of the human body. The measurement module can record results of multiple measurements and compare the results to determine whether there are progressive changes in each part of the human body, preferably whether the hemorrhoids increase, whether the abnormal moles continue to increase, and whether the pigmented areas expand.

The toilet apparatus of the present disclosure can automatically adjust the position of the flushing nozzle according to the user's body size and sitting position, such that the flushing nozzle can always accurately flush the parts that need to be cleaned, without the need to manually adjust the position of the nozzle or move the body. In addition, the toilet apparatus of the present disclosure can be used in a gravity-free environment to solve the problem of alignment between the collecting device and the body part and reduce the difficulty for the astronauts to go to the toilet.

### BRIEF DESCRIPTION OF THE DRAWINGS

FIG. 1 schematically illustrates a working principle of a toilet apparatus according to an embodiment of the present disclosure.

FIG. 2 is a schematic diagram of a measurement execution module according to an embodiment of the present disclosure.

FIG. 3 schematically illustrates a working principle of a toilet apparatus according to an embodiment of the present disclosure.

FIG. 4 schematically illustrates a working principle of a toilet apparatus according to another embodiment of the present disclosure.

FIG. 5 is a flow diagram of a method for flushing the human body by using the toilet apparatus of the present disclosure.

FIG. 6 is a flow diagram of a method for flushing the human body by using the toilet apparatus of the present disclosure.

FIG. 7 is a flow diagram of a method for flushing the human body by using the toilet apparatus of the present disclosure.

The same number in the accompanying drawings represents the same or similar components.

### DETAILED DESCRIPTION OF EMBODIMENTS

As shown in FIG. 1, a user 1 sits on a toilet bowl 2 of a toilet apparatus on which a toilet seat is provided. The toilet apparatus includes at least one intelligent flushing module. The intelligent flushing module includes at least one flushing execution module 30. The flushing execution module 30 includes a water pump, a flushing nozzle and a servo-mechanism, where the flushing nozzle is configured to move and rotate spatially under the drive of the servo-mechanism, and eject water to flush the human body. The intelligent flushing module includes at least one control module 20. The control module 20 includes at least one measurement module, at least one recognition module 22 and at least one flushing control module 21. The measurement module includes at least one measurement control module 23 and at least one measurement execution module 25, where the measuring execution module 25 includes at least one camera 27, at least one line laser 26, a known servo-mechanism and a circuit. The camera 27 and the line laser 26 are arranged inside the toilet bowl 2 and below the toilet seat. Since the measurement execution module 25 is located below the human body, the linear laser beams emitted by the line laser 26 can irradiate the human body within the toilet seat, and the camera 27 can take images of the human body surface within the toilet seat when the user 1 sits on the toilet seat. The camera 27 is provided with a filter, which can merely transmit the light having the same wavelength as the laser beams, thereby protecting the user's privacy. The measurement module measures the human body by 3D laser scanning to obtain the surface 3D point cloud of parts within the toilet seat. The measurement control module 23 can generate a 3D model of the body surface according to the surface 3D point cloud. The measurement control module 23 can transmit the point cloud and/or the 3D model of the body surface to the recognition module 22, and the recognition module 22 can identify the certain parts, including anus, external genitalia and urethra according to these data, and calculate their 3D positions. The 3D position information of the parts is transmitted to the flushing control module 21. The flushing control module 21 can control the movement of the flushing execution module 30 according to the spatial position of the parts to be flushed, adjusting the spatial position of the flushing nozzle to allow the water flow to flush accurately the parts to be flushed.

The recognition module 22 can determine the gender of the user 1 according to the identified parts, and can approximately determine the age according to the point cloud and/or the dimensions of the body model. The flushing control module 21 can select a flushing option according to the gender and age of the user 1. The flushing option includes at least one flushing option for female adults, at least one flushing option for girls and at least one flushing option for males. The flushing option involves the combination of parts to be flushed, sequence, the direction of water flow, flushing time and the intensity of water flow, where the combination of the parts to be flushed preferably includes external genital and anus. The preferred flushing program for female adults includes flushing the vulva and anus, and the direction of water flow is from the front to back of the human body. Preferably, when the user is an adult female, the flushing option for female adults is automatically selected.

When the user 1 sits on the toilet seat, the measurement module can perform multiple measurements on the human body. Preferably, a time interval between adjacent two measurements is no more than five seconds. The measurement module can monitor the defecation and/or urination in real time, and transmit the related information to the flushing control module 21. The flushing control module 21 can determine whether the user 1 experiences defecation or urination based on the information, and select a flushing option accordingly. Preferably, the flushing option for female adults is selected when a woman urinates.

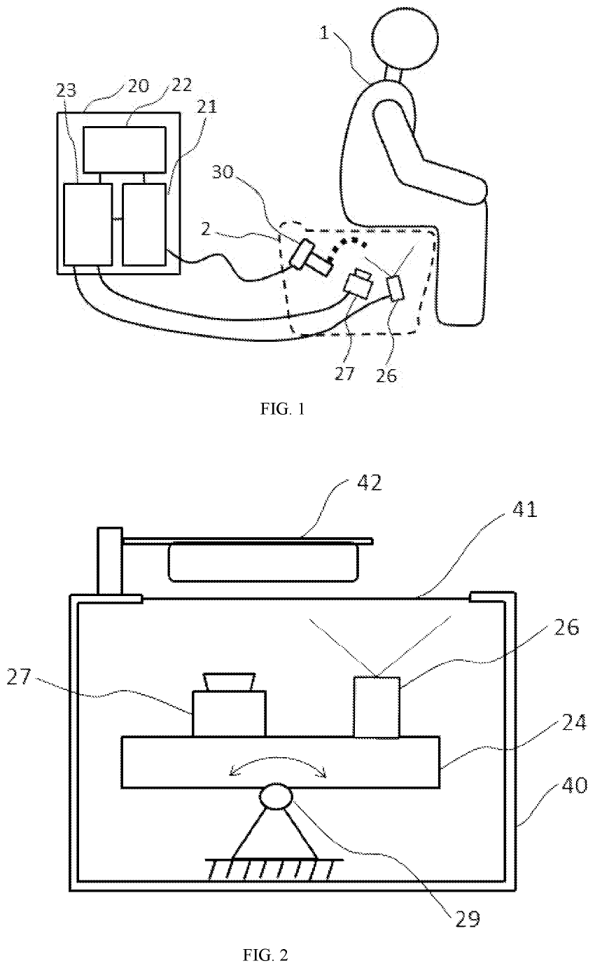

As shown in FIG. 2, the measurement execution module 25 includes a camera 27, a line laser 26, a servo-mechanism and a circuit. The camera 27 and the laser 26 are mounted on a base 24, which can swing around a rotation shaft 29. The servo-mechanism drives the camera 27 and the laser 26 to swing together to scan and photograph the human body. The corresponding point cloud can be obtained by capturing laser spot images at different angles. The measurement execution module 25 includes a case 40, a light-transmitting window 41 and a wiping mechanism 42, where the case 40 and the light-transmitting window 41 are in sealed connection to form a waterproof and moisture-proof space in which the camera 27, the laser 26, the servo-mechanism and the circuit are arranged. The wiping mechanism 42 can remove water droplets on the light-transmitting window 41 to keep the light-transmitting window 41 clean. The measurement execution module 25 is arranged inside the toilet bowl and near the side wall of the toilet bowl. The measurement execution module 25 can also be arranged on a slide rail and move along the slide rail under the drive of the servo-mechanism to scan the human body. Moreover, it can also be arranged on a push rod and driven by the push rod to complete the measurement.

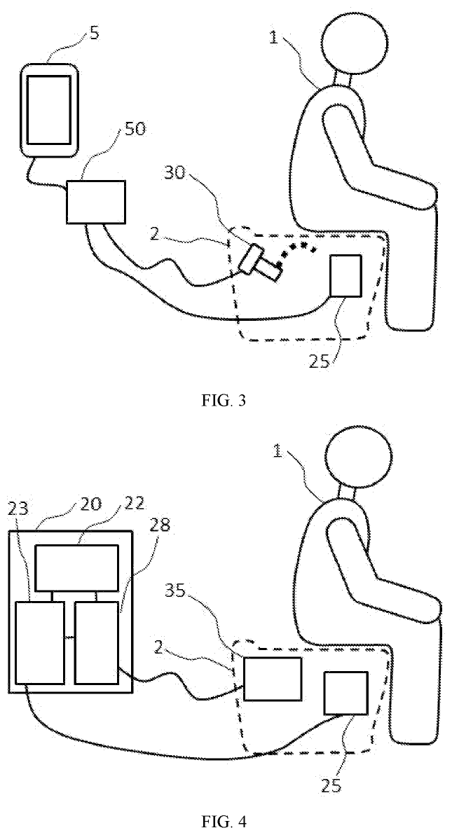

As shown in FIG. 3, the intelligent flushing module includes at least one intelligent terminal 5 and at least one drive control module 50. The intelligent terminal 5 includes a toilet control application, and the toilet control application includes at least one recognition module 22, at least one flushing control module 21 and at least one measurement control module 23. The measurement control module 23 can control the measurement execution module 25 through the drive control module 50 to perform the 3D measurement on the human body, so as to obtain the 3D data of human body and generate a partial model of the human body. The recognition module 22 can identify each part of the human body and determine its 3D position. The flushing control module 21 can control the flushing execution module 30 through the drive control module 50 to flush the human body according to the 3D positions of the parts. The measurement execution module 25 includes a camera and/or a depth sensing camera system in the intelligent terminal 5.

The toilet apparatus of the disclosure can be used in a gravity-free environment, for example, it can be used by an astronaut in a space station. As shown in FIG. 4, the toilet apparatus includes at least one intelligent flushing module. The intelligent flushing module includes at least one control module 20. The control module 20 includes at least one measurement module, at least one recognition module 22 and at least one collection module. The collection module includes at least one collection execution module 35 and at least one collection control module 28. The measurement module includes at least one measurement control module 23 and at least one measurement execution module 25. In use, the measurement module can continuously perform 3D measurements on the human body to obtain the point cloud of the body surface, and can monitor the process of defecation and/or urination in real time, where the measurement indexes include changes in the anus/urethral orifice and the discharged faces and urine. The measurement module can build the 3D model of the human body. The recognition module 22 can identify each part of the human body according to the point cloud and/or the 3D model of the human body, and can calculate the 3D spatial position of the body's anus, urethral orifice, etc. The measurement module can monitor the discharged feces and urine in real time. When discharged from the body, the feces/urine in the air can reflect the laser/visible light/ultrasound, which can be detected by the measurement mechanism. The collection control module 28 can control the collection execution module 35 to move to the corresponding part of the human body according to the information transmitted by the measurement module and the recognition module 22. The collection execution module 35 includes a feces collection mechanism and a urine collection mechanism, where the feces collection mechanism and the urine collection mechanism each include a collection tube. One end of the collection tube is an open end and the other end is connected to a negative pressure suction container. The negative pressure suction container can generate negative pressure, so that the excrement is sucked into the collection tube from the open end. The open ends of the collection tubes are respectively aligned with the anus and the urethral orifice. The collection execution module 35 includes a flushing nozzle, which can be arranged at the open end of the collection tube. Preferably, a water outlet of the nozzle is annularly arranged at the inner wall of the open end. Optionally, the nozzle may not be arranged on the collection tube. The measurement module can monitor the user's defecation and/or urination process in real time. When the measurement module detects the discharged feces and/or urine, the collection execution module 35 can collect the feces/urine through vacuum suction and/or air blowing. The collection execution module 35 can also continuously generate negative pressure to suck excrement. When the flushing function is activated, the collection execution module 35 can flush the corresponding parts of the human body and collect the water droplets. The toilet apparatus of the disclosure can also be arranged under a wheelchair cushion or a bed for the disabled.

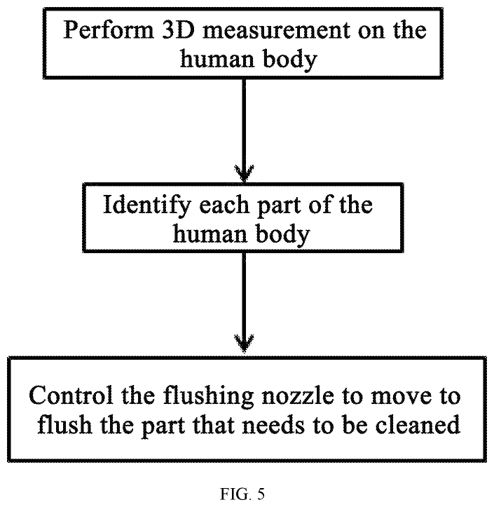

As shown in FIG. 5, the present disclosure further provides a method for flushing the human body by using the toilet apparatus, including the following steps.

a. 3D measurement is performed on the human body to obtain the data related to the body surface.

b. Each part of the human body is identified based on the data of the body surface to determine its 3D spatial position.

c. The flushing execution module is moved to flush the parts that need to be cleaned.

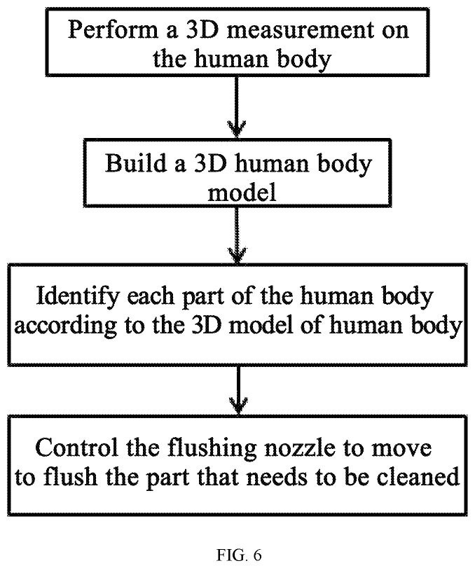

As shown in FIG. 6, another method for cleaning the human body includes the following steps.

a. The 3D measurement is performed on the human body to obtain data of the surface of the human body within the toilet seat.

b. The 3D human body model is established according to the body surface data.

c. Individual parts of the human body are identified based on the 3D model to determine their 3D spatial positions.

d. The flushing nozzle is moved to flush the parts that need to be cleaned.

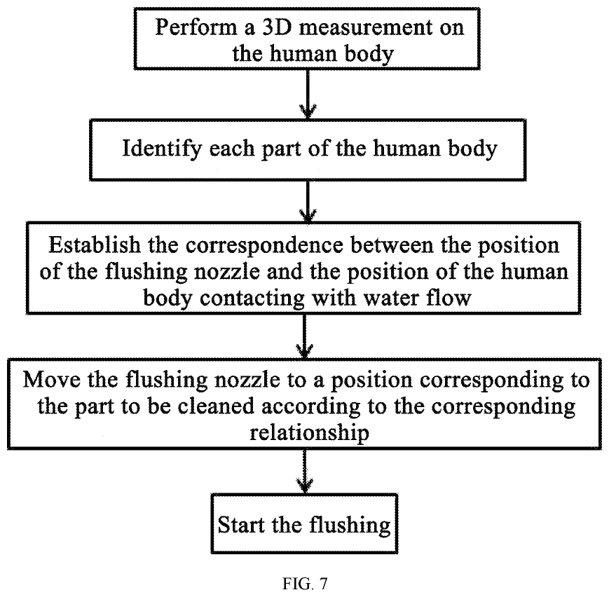

As shown in FIG. 7, a method for flushing the human body includes the following steps.

a. A 3D measurement is carried out on the human body.

b. Individual parts of the human body are identified to determine their 3D spatial positions.

c. The correspondence between the position of the flushing nozzle and the position of the body surface contacting water flow is established.

d. The part to be cleaned is determined, and the flushing nozzle is moved to the corresponding position of the part to be cleaned according to the corresponding relationship.

e. The part to be cleaned is flushed with ejected water flow.

What is claimed is:

1. A toilet apparatus, comprising:
a toilet seat;
a water supply system;
at least one flushing module;
at least one measurement module; and
at least one recognition module;
wherein the flushing module comprises at least one flushing execution module and at least one flushing control module;
wherein the measurement module is configured to perform a three-dimensional (3D) measurement of a human body within the toilet seat to obtain a 3D point cloud of a surface of the human body within the toilet seat; and the measurement module is configured to establish a 3D model of the human body according to the 3D point cloud;
the recognition module is configured to identify certain parts of the human body within the toilet seat according to the 3D point cloud and/or the 3D model of the human body, and calculate a 3D position of each of the certain parts; and
the flushing control module is configured to control the flushing execution module to move towards a part that needs to be cleaned according to its 3D position and flush the part with a flushing water flow.

2. The toilet apparatus of claim 1, wherein the measurement module comprises a measurement control module and a measurement execution module; the measurement control module is configured to control the measurement execution module to perform 3D measurement of the human body within the toilet seat to obtain the 3D point cloud; and the measurement control module is operable to establish the 3D model according to the 3D point cloud.

3. The toilet apparatus of claim 2, further comprising:
at least one terminal comprising at least one of the recognition module, the flushing control module and the measurement control module.

4. The toilet apparatus of claim 1, wherein the flushing execution module comprises a water pump, a flushing nozzle and a first servo-mechanism; and the first servo-mechanism is configured to drive the flushing nozzle to move towards and flush the part that need to be cleaned.

5. The toilet apparatus of claim 1, wherein the measurement execution module comprises at least one camera, at least one line laser and a second servo-mechanism;
the camera and the line laser are arranged below the toilet seat; the line laser is configured to emit linear laser beams to irradiate the human body within the toilet seat; and the camera is configured to capture images of the surface of the human body within the toilet seat.

6. The toilet apparatus of claim 5, wherein the camera is provided with a filter to allow light having the same wavelength as the linear laser beams to pass through.

7. The toilet apparatus of claim 1, further comprising:
at least one collection module comprising a collection execution module and a collection control module;
wherein the collection control module is configured to control the collection execution module to move to a position corresponding to the part that needs to be cleaned according to at least one of the 3D model of the human body, the 3D point cloud and the 3D position of the part; and
the collection execution module is configured to collect excrement and/or urine, and water generated after flushing the human body.

8. The toilet apparatus of claim 1, wherein the recognition module is configured to determine gender and/or age of a user according to identified parts of the human body within the toilet seat, and determine the age of the user according to the 3D point cloud and/or the 3D model of the human body.

9. The toilet apparatus of claim 8, wherein the flushing control module is configured to select a flushing option according to the determined gender and/or age of the user.

10. The toilet apparatus of claim 1, wherein the measurement module is configured to monitor defecation and/or urination of the human body in real time; and
the flushing control module is configured to select a flushing option according to the defecation and/or urination information provided by the measurement module.

11. The toilet apparatus of claim 1, wherein the measurement module is configured to detect a 3D shape of each of the certain parts of the human body within the toilet seat and/or a smoothness of a skin of the human body within the toilet seat to determine whether each of the certain parts and/or the skin surface of the human body within the toilet seat is/are in a normal state.

12. The toilet apparatus of claim 1, wherein the measurement module is operable to record and compare results of multiple measurements to determine whether there are progressive changes in the certain parts and/or the skin surface of the human body within the toilet seat.

13. The toilet apparatus of claim 4, wherein the flushing control module is operable to establish a mathematical model and/or a 3D model of the flushing water flow, and establish a corresponding relationship between a position of the flushing nozzle and a part of the human body contacting the flushing water flow and/or a position where the surface of the human body contacts the flushing water flow according to the 3D point cloud and/or the 3D model of the human body and the mathematical model and/or the 3D model of the flushing water flow.

14. A method for flushing a human body by using the toilet apparatus of claim 1, comprising:
(a) performing 3D measurement on the human body within the toilet seat to obtain the 3D point cloud of the human body;
(b) identifying each of the certain parts of the human body within the toilet seat according to the 3D point cloud; and calculating the 3D position of each of the certain parts; and
(c) moving the flushing execution module to flush a part that needs to be cleaned according to its 3D position.

15. The method of claim 14, comprising:
after step (a), establishing the 3D model of the human body according to the 3D point cloud such that when step (b) is performed, each of the certain parts of the human body within the toilet seat is identified according to the 3D point cloud and/or the 3D model of the human body, and the 3D position of each of the certain parts is calculated.

16. The method of claim 14, comprising:
after step (c), establishing a correspondence relationship between a position of the flushing execution module and a position of the surface of the human body contacting the flushing water flow.

17. The method of claim 14, comprising: after step (c),
establishing, by the flushing control module, a mathematical model and/or a 3D model of the flushing water flow; and establishing a corresponding relationship between a position of the flushing control module and a position where the flushing water flow contacts the human body and/or the surface of the human body according to the 3D point cloud and/or the 3D model of the human body and the mathematical model and/or the 3D model of the flushing water flow; and
controlling, by the flushing control module, the flushing execution module to move to a position corresponding to a part of the human body that needs to be cleaned according to the corresponding relationship.

18. A method for detecting skin conditions of a human body by using the toilet apparatus of claim 12, comprising:
(a) detecting, by the measurement module, a shape of each of the certain parts and/or smoothness of the skin of the human body within the toilet seat; and
(b) determining whether each of the certain parts and/or the skin of the human body within the toilet seat is in a normal state.

19. The method of claim 18, further comprising:
after step b, recording and comparing multiple detection results to determine whether there is a progressive change in the certain parts and/or the skin of the human body within the toilet seat.
